(19) United States
(12) Patent Application Publication
(10) Pub. No.: US 2003/0206138 A1
(43) Pub. Date: Nov. 6, 2003

(54) Parasitic antenna

(76) Inventor: Chien-Chih Chiu, Dali City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/424,453

(22) Filed: Apr. 28, 2003

(30) Foreign Application Priority Data
May 2, 2002 (TW) 091109142

(51) Int. Cl. H01Q 11/12; H01Q 7/00

(52) U.S. Cl. 343/741; 343/866

(57) ABSTRACT

A parasitic antenna includes a loop antenna and a metallic inductor, which is positioned on a side of the loop antenna and is isolated from the loop antenna. Upon receiving a signal, the loop antenna produces an electric field. The electrical field produced by the loop antenna radiates energy to the metallic conductor, causing the metallic conductor to produce an induced electric current, thereby generating an electrical field radiating outward. Because the direction of the electrical field produced by the metallic conductor is the same as that of the loop antenna, the radiating performance of the loop antenna is enhanced.

This application claims the benefit of Taiwan application Serial No. 91109142, filed May 2, 2002.

### BACKGROUND OF THE INVENTION

1. Field of the Invention

The invention relates in general to an antenna, and more particularly to a parasitic antenna.

2. Description of the Related Art

Wireless communication is important with respect to increasing the convenience of peoples' lives. Regarding the design of wireless devices, antenna performance often determines the quality of signal transmission and reception. For this reason, the improvement of antenna performance is a major subject for researchers.

Referring to FIG. 1, a schematic view of a conventional stimulated dipole antenna is shown. Two electric currents i, whose phases differ from each other by 180 degrees, are input to the two poles of a dipole antenna. Because the stimulating electric currents in two poles are in the same direction, the antenna is stimulated to radiate an electrical field \vec{E}, whose distribution is shown as the dotted line in FIG. 1. In practical applications, a loop antenna is usually used to fabricate an antenna structure of lower frequency (lower than 1 GHz). FIG. 2A shows the loop antenna 250, forming a closed section, including a terminal coupled to the output terminal OUT of the radio frequency circuit 210 and the other terminal coupled to the ground terminal of the radio frequency circuit 210. The stimulating electric current, applied to the loop antenna 250 from the output terminal OUT of the radio frequency circuit 210, flows along the loop antenna 250 and back to the ground terminal of the radio frequency circuit 210, which will induce a magnetic field \vec{H} with a downward direction as shown in FIG. 2B.

In terms of the performance of a loop antenna, the area of the closed section formed by the loop antenna is an important factor when examining antenna function. Generally speaking, a loop antenna with a larger loop has better performance than one with a smaller loop. However, enlarging the area the antenna occupies in order to enhance performance will violate the design objective, to make devices thin and small. Therefore, enhancing antenna performance within a limited area of the loop antenna becomes an important issue. Moreover, since the area occupied by the loop antenna is not available for placing other components, due to possible negative influence on the antenna performance, precious areas of the circuit board will be wasted, which is inefficient. The dilemma is how to enlarge the antenna to improve antenna performance and how to reduce the occupied area of the loop antenna to enhance the efficient utilization of the circuit board.

Therefore, in order to enhance the performance of the loop antenna in a limited area of the circuit board, the structure of the prior art loop antenna has indeed to be adjusted to satisfy consumer demand that devices are thin and small.

### SUMMARY OF THE INVENTION

It is therefore an object of the invention to provide a parasitic antenna for improving antenna performance.

The invention achieves the above-identified objectives by providing a parasitic antenna as described below.

A parasitic antenna includes a loop antenna and a metallic inductor, which is positioned on a side of the loop antenna and is isolated from the loop antenna (the metallic inductor does not have direct physical contact with the loop antenna). The electrical field produced as the loop antenna is stimulated will radiate energy into the metallic inductor to create an induced electric current. As a result, the metallic inductor, like a dipole antenna, will generate an electrical field radiating outwards according to the induced electric current. Since the direction of the electrical field produced by the metallic inductor is the same as that of the electrical field produced by the loop antenna, the radiation performance of the loop antenna can be enhanced. In practical applications, the metallic inductor can be used singly or in pairs, positioned inside, outside, or on the top of the loop antenna. In terms of appearance, the metallic inductor can have the shape of a long bar, or a long curved bar corresponding with the shape of the loop antenna, thereby increasing the coupling effect of the radiating energy.

However, the shape of the metallic inductor is not limited to corresponding with that of the loop antenna. Metallic inductors of any other shape will also conform with the spirit of the invention to enhance the intensity of the electrical field radiated by the antenna, but antenna performance will differ according to the shape of the metallic inductor. The metallic inductor can be positioned as close as possible to the loop antenna (but not in contact with the loop antenna) so that the metallic inductor can receive more radiating energy to improve antenna performance. Moreover, the distance between the metallic inductor and the loop antenna is another design point to be considered, which is not related to the shape of the metallic inductor. When seeking a balance between antenna performance and the area occupied by the loop antenna, the length of the loop antenna needs to be smaller than one-tenth of the wavelength according to the operating frequency.

Other objectives, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic view of a conventional stimulated dipole antenna;

FIG. 2A (Prior Art) is a schematic view of a conventional loop antenna;

FIG. 2B (Prior Art) shows the magnetic field produced as the loop antenna is stimulated in FIG. 2A;

FIG. 3 is a schematic view of a parasitic antenna according to a preferred embodiment of the invention;

FIG. 4A shows the distribution of the electrical field induced on the metallic inductor of FIG. 3;

FIG. 4B shows the distribution of the net electrical field induced by the metallic inductor in FIG. 4A;

FIG. 5 shows the distribution of the electrical field induced by the loop antenna in FIG. 3;

FIG. 6 is a schematic view showing the metallic inductor positioned outside the loop antenna;

FIG. 7A is a schematic view showing the metallic inductor positioned on the top of the loop antenna; and

FIG. 7B is a cross-sectional view of FIG. 7A, taken along the line 7B-7B.

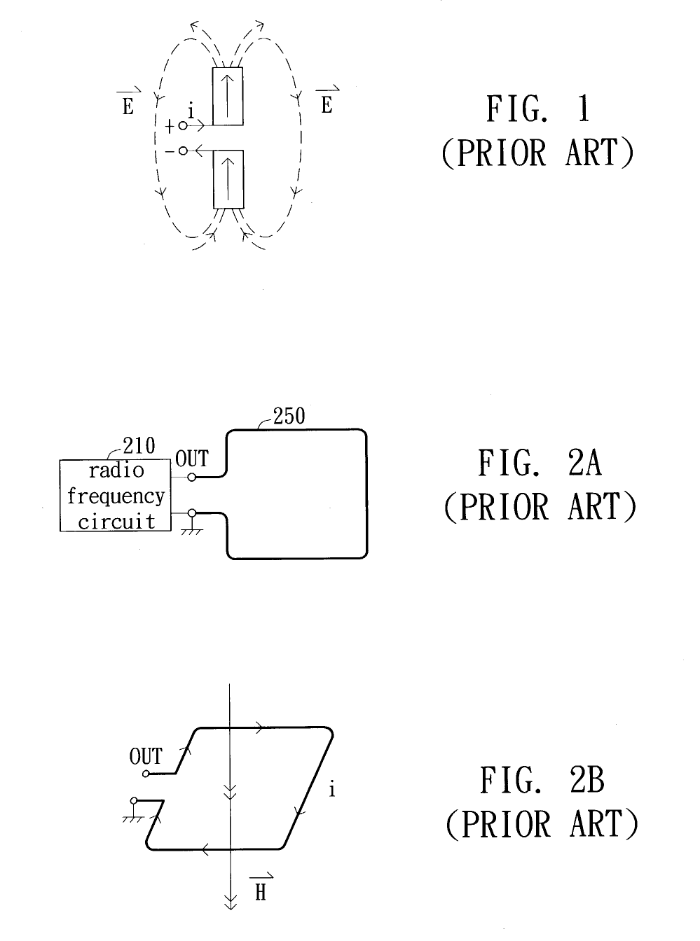

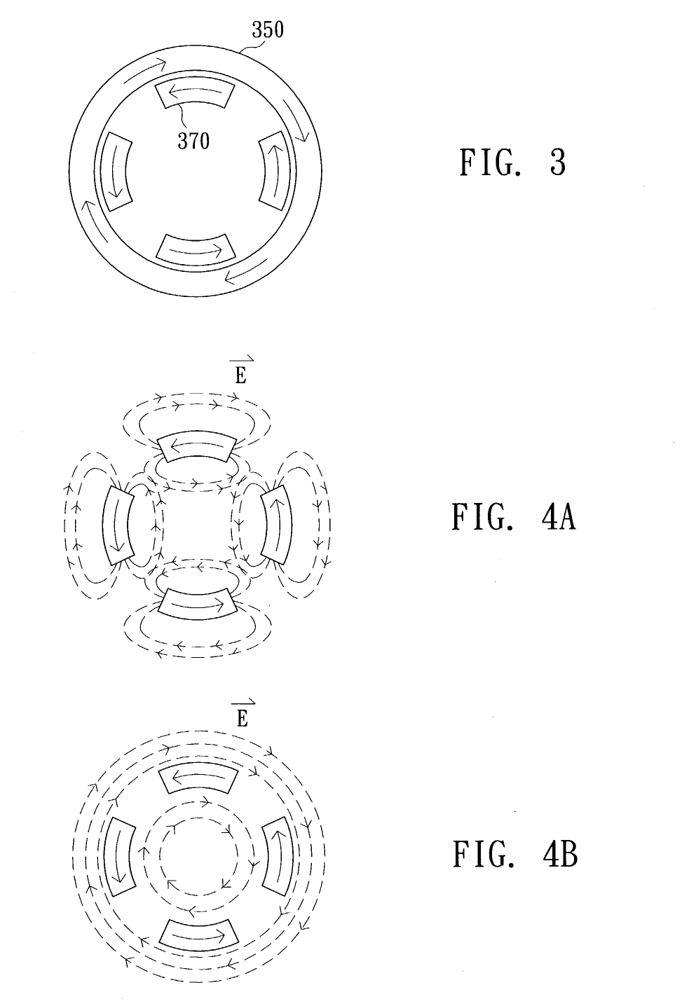

### DETAILED DESCRIPTION OF THE INVENTION

Referring to FIG. 3, a schematic view of the parasitic antenna according to a preferred embodiment of the invention is shown. The parasitic antenna includes a loop antenna 350 and a metallic inductor 370, which is positioned inside the loop antenna 350 but is isolated from the loop antenna 350 (the metallic inductor 370 does not have direct contact with the loop antenna 350). As the loop antenna 350 is to be stimulated, the stimulating electric current is applied to the loop antenna 350 (the direction of the stimulating electric current is shown as the arrow on the loop antenna 350), and an electrical field with the same direction as that of the stimulating electric current will be induced to radiate outwards in the loop antenna 350. As the electrical field radiates to the metallic inductor 370, an electrical field with the opposite direction as that of the antenna electrical field will be induced on the surface of the metallic inductor 370 (according to the boundary condition that the tangential electrical field on the surface of an inductor should be zero). An electric current is thus induced on the surface of the metallic inductor 370, and the direction of the induced electric current is shown as the arrow on the metallic inductor 370 in FIG. 3.

Referring to FIG. 4A, a schematic view of the distribution of the electrical field induced on the metallic inductor of FIG. 3 is shown. The direction of the induced electric current on the metallic inductor is shown as the solid arrow in FIG. 4A. According to the description of the dipole antenna in the prior art, each metallic inductor can actually be an electric dipole source. Therefore, each metallic inductor can function as a dipole antenna to produce an electrical field \vec{E} radiating outwards. The distribution of the electric field \vec{E} is shown as the dotted line in FIG. 4A. Electrical fields generated by the metallic inductors are superposed to give the resultant distribution of the electrical field as shown in FIG. 4B.

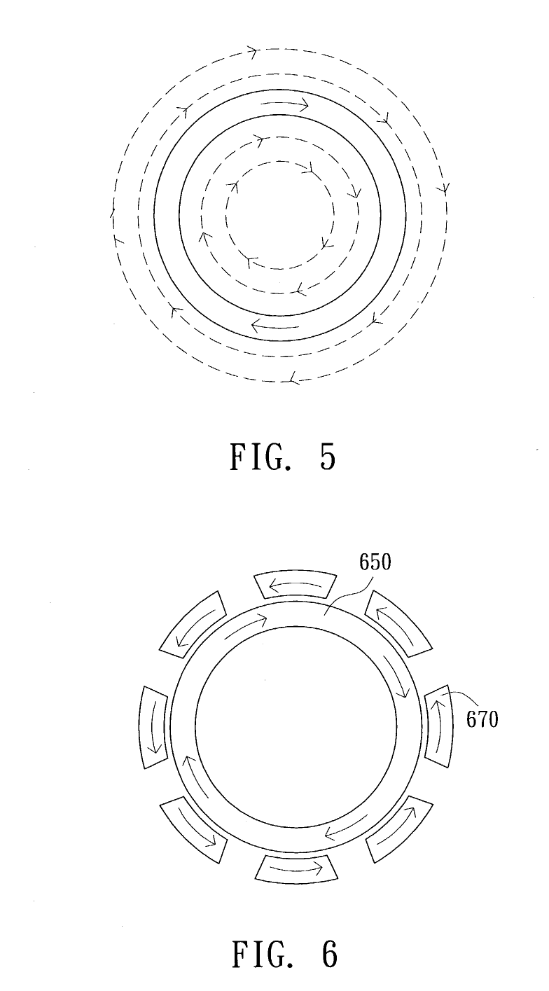

Referring to FIG. 5, a schematic view of the distribution of the electrical field induced by the loop antenna in FIG. 3 is shown. The stimulating electric current on the loop antenna is shown as the solid arrow, and the distribution of the induced electrical field is shown as the dotted arrow in FIG. 5. Referring to FIG. 4B and FIG. 5, the electrical field generated by the induced electric current on the metallic inductor is found to have the same direction (clockwise in FIG. 5) as that of the electrical field induced by the loop antenna, thereby increasing the radiation effect of the loop antenna and enhancing the antenna performance. Since the induced electric current on the metallic inductor is generated from the energy of the electrical field radiated by the loop antenna, an additional electrical source is not needed. That is to say, the loop antenna, having a plurality of metallic inductors to form a parasitic antenna, will outperform a loop antenna of the same structure without a metallic inductor.

Moreover, when metallic inductors are positioned inside the loop antenna, the electrical field of the loop antenna, which scatters inwards, will be reflected by the metallic inductor, thereby increasing the radiating effect of the loop antenna. In practical applications, the metallic inductor can be a single item or in pairs, positioned inside, outside, or on the top of the loop antenna. The shape of the metallic inductor can be a long bar or a long curved bar corresponding in shape with that of the loop antenna to increase the coupling effect of the radiating energy.

However, the shape of the metallic inductor is not limited to corresponding with that of the loop antenna. Metallic inductors of any other shape will conform with the spirit of the invention to increase the intensity of the electrical field radiated by the antenna, but the antenna performance will differ according to the shape of the metallic inductor. The metallic inductor can be positioned as close as possible to the loop antenna (but not in direct contact with the loop antenna) so that the metallic inductor can receive more radiating energy to enhance the antenna performance. Moreover, the distance between the metallic inductor and the loop antenna is another design point to be considered, which is not related to the shape of the metallic inductor.

The area occupied by the loop antenna is also not limited to the shape of a circle or a rectangle, and is not limited to be only one circle. The more circuit circles the loop antenna has in a fixed area, the more intense magnetic field the loop antenna induces. In addition to increasing the number of circles of the loop antenna, the intensity of the electrical field radiated by the antenna can also be improved by adding one or more small metallic inductors in the area surrounding the loop antenna. Moreover, the metallic inductor can be positioned in the area occupied by the loop antenna, which was conventionally considered to be useless and was not utilized by any component. Therefore, the circuit board can be used more efficiently by increasing the radiating effect of the loop antenna without using extra circuit board area. In other words, the scale of a parasitic antenna can be smaller than that of a loop antenna when two antennas have the same performance. When seeking a balance between the antenna performance and the area occupied by the loop antenna, the length of the loop antenna needs to be smaller than one-tenth of a wavelength according to the operating frequency.

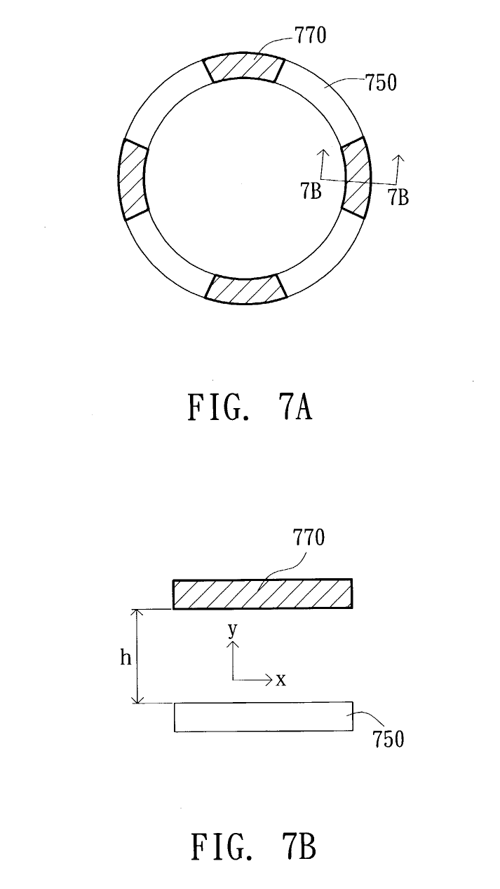

In the same spirit of the invention, the metallic inductors 670 can also be situated outside and isolated from the loop antenna 650 as shown in FIG. 6, or the metallic inductors 770 can be positioned on the top of and isolated from the loop antenna 650 as shown in FIG. 7A. When viewed along the line 7B-7B of FIG. 7A, the metallic inductor 770 can be seen clearly positioned in the normal direction of the loop antenna 750 (the y direction in FIG. 7B) and departing from the loop antenna 750 by a height h.

As described above, the parasitic antenna provided in the invention at least has the advantages described below.

1. Cost can be reduced. According to the invention, the intensity of the electrical field radiated by the antenna is increased by stimulating the metallic inductor around the loop antenna with its own radiating energy to induce an electrical field of the same direction as that of the electrical field of the loop antenna but not by increasing the input power of the antenna. Since it is not necessary to increase the input power of the antenna, the radio frequency circuit does not have to be adjusted to increase the output power. On the other hand, if higher output power of the radio frequency circuit has to be provided to drive the antenna to enhance antenna performance, an extra power amplifier circuit needs to be positioned in the radio frequency circuit. As a result, the extra amplifier and bias components will increase the cost. According to the invention, the original radio frequency circuits design does not need to be changed; the metallic inductor simply needs to be situated around the loop antenna to enhance the antenna performance, which can greatly reduce production cost.

2. The circuit board area utilization rate can be increased. The parasitic antenna provided in the invention includes metallic inductors positioned in the area occupied by the loop antenna, which was conventionally unable to have any components inside its loop. Therefore, the area of the circuit board, which was seen to be useless before, can be used more efficiently according to the invention. From another point of view, because the radiating intensity of the antenna is increased without needing extra circuit board area, the utilization rate of the circuit board area can be increased, and the cost per unit area of the circuit board can be reduced.

3. The volume of the circuit board can be reduced. The parasitic antenna provided in the invention can increase the radiating effect of the antenna without using extra circuit board area, or the parasitic antenna can have a smaller scale than the typical loop antenna in case of the same antenna performance. As a whole, the volume of the circuit board can also be reduced by using the parasitic antenna. The products are thus more competitive with other products on the market.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A parasitic antenna, comprising:
a loop antenna; and
a metallic inductor, positioned on a side of the loop antenna and isolated from the loop antenna for receiving energy radiated from the loop antenna.

2. The parasitic antenna according to claim 1, wherein the loop antenna and the metallic inductor are at the same level.

3. The parasitic antenna according to claim 2, wherein the metallic inductor is positioned inside the loop antenna.

4. The parasitic antenna according to claim 1, wherein the metallic inductor is positioned in the normal direction of the loop antenna.

5. The parasitic antenna according to claim 1, wherein the length of the loop antenna is smaller than one tenth of a wavelength according to an operating frequency.

6. The parasitic antenna according to claim 1, wherein the metallic inductor is shaped like a long bar.

7. The parasitic antenna according to claim 6, wherein the metallic inductor is shaped like a long curved bar with a radian corresponding to the loop antenna.

8. A parasitic antenna, comprising:
a loop antenna; and
a plurality of metallic inductors, uniformly positioned on a side of the loop antenna and isolated from the loop antenna for receiving energy radiated from the loop antenna.

9. The parasitic antenna according to claim 8, wherein the loop antenna and the metallic inductors are at the same level.

10. The parasitic antenna according to claim 8, wherein the metallic inductors are positioned inside the loop antenna.

11. The parasitic antenna according to claim 8, wherein the metallic inductors are arranged in a ring.

12. The parasitic antenna according to claim 8, wherein the metallic inductors are shaped as long bars.

13. The parasitic antenna according to claim 8, wherein the metallic inductors are positioned in the normal direction of the loop antenna.

14. The parasitic antenna according to claim 8, wherein the length of the loop antenna is smaller than one tenth of a wavelength according to an operating frequency.

15. The parasitic antenna according to claim 12, wherein the metallic inductors are shaped as long curved bars, each having a radian corresponding to the loop antenna.
